(19) United States
(12) Patent Application Publication
(10) Pub. No.: US 2007/0282882 A1
(43) Pub. Date: Dec. 6, 2007

(54) Customizing and aggregating customer catalogs

(75) Inventors: Ankur Agarwal, Redmond, WA (US); Spencer A. Skyles, Bothell, WA (US); Vinayak D. Tadas, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/511,705

(22) Filed: Aug. 28, 2006

Related U.S. Application Data
(60) Provisional application No. 60/810,305, filed on Jun. 2, 2006.

(51) Int. Cl. G06F 7/00

(52) U.S. Cl. 707/101

(57) ABSTRACT

Aspects of the subject matter described herein relate to customizing and aggregating catalogs. In aspects, a user configures a virtual catalog to be created from one or more other catalogs. The user may specify inclusion and exclusion rules that indicate what catalogs, categories, products, and variants to include or exclude in the virtual catalog. The user may also specify that certain properties be overridden in the virtual catalog. If desired, the virtual catalog may be materialized to improve performance or for other reasons. Changes that occur to derived from catalogs may be detected and used in rebuilding a virtual catalog.

### CROSS REFERENCE TO RELATED APPLICATION

This application claims the benefit of U.S. Provisional Application No. 60/810,305, filed Jun. 2, 2006, entitled CUSTOMIZING AND AGGREGATING CUSTOMER CATALOGS, which application is incorporated herein in its entirety.

### BACKGROUND

A company that markets and sells goods often resells goods available from other companies. To do so, the company may get catalogs of products from its vendors and create a catalog of available goods that does not reference the other companies from which the goods come. In creating the catalog, for goods that come from other companies, the company may have a group of employees who include products from these catalogs, change prices, descriptions, names, part numbers, and so forth to provide for a markup, to add additional information, to remove the information that indicates that the goods come from another company. Goods from other companies may cease to be available, may have price changes, or may have changes in name, description, or other properties of the goods. The process of creating a catalog of goods and keeping the catalog up-to-date can be very time consuming and expensive.

### SUMMARY

Briefly, aspects of the subject matter described herein relate to customizing and aggregating catalogs. In aspects, a user configures a virtual catalog to be created from one or more other catalogs. The user may specify inclusion and exclusion rules that indicate what catalogs, categories, products, and variants to include in the virtual catalog. The user may also specify that certain properties from the inherited catalogs be overridden in the virtual catalog. If desired, the virtual catalog may be materialized to improve performance or for other reasons. Changes that occur to derived from catalogs may be detected and used in rebuilding a virtual catalog.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram representing an exemplary catalog component in accordance with aspects of the subject matter described herein;

FIG. 4 is a block diagram that generally represents an exemplary relationship between catalogs in accordance with aspects of the subject matter described herein; and

FIG. 5 is a flow diagram that generally represents exemplary actions that may occur in aggregating catalogs in accordance with aspects of the subject matter described herein.

### DETAILED DESCRIPTION

### Exemplary Operating Environment

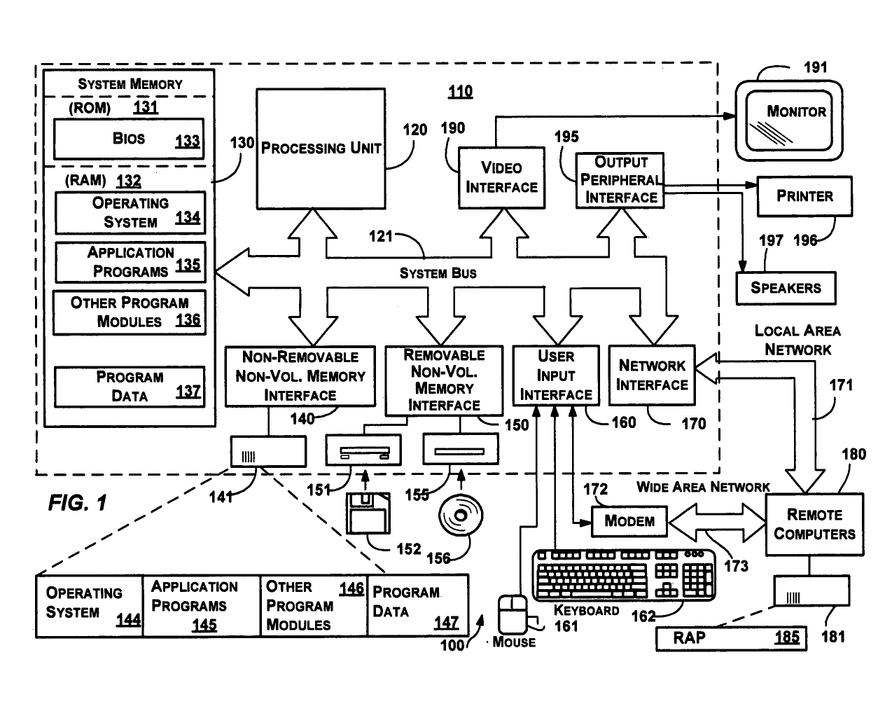

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

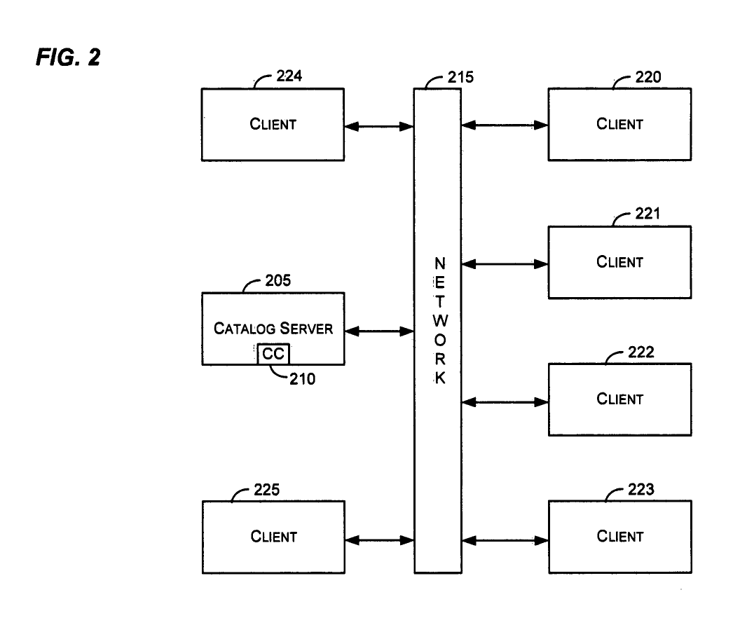

FIG. 2 is a block diagram representing an exemplary environment in which aspects of the subject matter described herein may be implemented. The environment includes a catalog server 205 and clients 220-225 and may include other components (not shown). The various entities may communicate with each other via a network 215 which may include intra-office networks and the Internet.

Each of the catalog server 205 and the clients 220-225 may be implemented on one or more computers (e.g., computer 110 as described in conjunction with FIG. 1). The catalog server 205 includes a catalog component 210 that is in charge of customizing and aggregating catalogs into virtual catalogs (described in more detail below). The catalog component 210 may also be in charge of providing access to the virtual catalogs to the clients 220-225.

In one embodiment, the catalog server 210 may host a web site that allows the clients 220-225 to view catalogs and to purchase items therefrom. In another embodiment, the catalog server 205 may host a database access component (which may be included in the catalog component 210, for example) that allows one or more of the clients 220-225 to access catalogs using a database protocol. The clients 220-225 may then use the information in hosting web sites to display and view the catalogs or portions thereof and to sell goods related thereto.

In other embodiments, the clients 220-225 and the catalog server 205 may use virtual catalogs for a variety of other purposes including analysis of market trends, planning, printing of hard copies of catalogs, and other purposes.

Although the environment described above includes one server and several clients, it will be recognized that more, fewer, or a different combination of these entities may be employed without departing from the spirit or scope of aspects of the subject matter described herein. Furthermore, in an embodiment, one or more clients may reside on the catalog server 205.

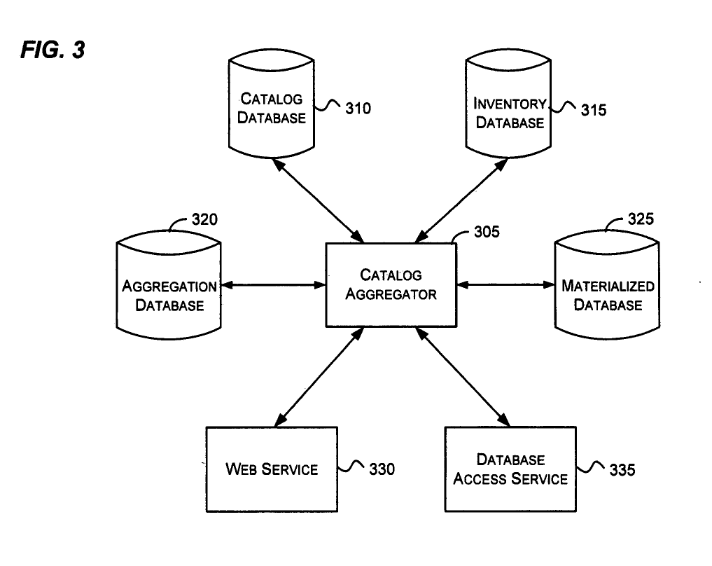

FIG. 3 is a block diagram representing an exemplary catalog component in accordance with aspects of the subject matter described herein. A catalog aggregator 305 creates virtual catalogs via a catalog database 310 and an inventory database 315. A virtual catalog is a catalog that is derived at least in part (e.g., aggregated) from one or more other catalogs.

In one embodiment, a virtual catalog may be derived from (e.g., aggregated from) any number of base catalogs and/or virtual catalogs. In another embodiment, a virtual catalog may be derived from either one other virtual catalog or from any number of base catalogs.

Base catalogs are catalogs in which categories, products, and variants may be defined and in which product information is stored. Categories may be hierarchical and may have many levels in the hierarchy. For example, a book catalog may include autobiography, biography, science fiction, fantasy, programming languages, and other categories which may each have subcategories. A category may be associated with products (e.g., books or other goods) and may be used to group a set of related products together. A product may be associated with zero or more categories and/or zero or more other products.

Each product and category in a catalog may be defined by one or more properties. Some exemplary properties include price, name, description, part number, manufacturer, ISBN, and the like, but it will be recognized that a product or category may be associated with many other, fewer, or different properties without departing from the spirit or scope of aspects of the subject matter described herein.

A product family may include a set of products that have common properties. For example, a product family may include products that have a name of shirt. Each product that has a property different from the common properties may be classified as a variant. For example, if a product family includes two products (e.g., a shirt that is red and has size 10 and a shirt that is blue and has size 12), then the shirt product family includes a variant that is red and size 10 and a variant that is blue and size 12.

In an embodiment, a virtual catalog may be represented as a table in a database (e.g., aggregation database 320). The rows in a virtual catalog table may contain references to corresponding rows from derived from catalog tables. Inclusion and exclusion rules stored in the aggregation database 320 may define which catalogs, categories, products, and/or variants from derived from catalogs (e.g., base or virtual) to include or exclude in the virtual catalog. These inclusion and exclusion rules may be stored in separate tables in the aggregation database 320. In an embodiment, the products and categories that match the inclusion/exclusion rules are used to create a virtual catalog.

Pricing rules stored in the aggregation database 320 may allow a price from a derived from catalog to be changed in the virtual catalog. For example, a pricing rule may indicate that certain products from certain catalogs have a 10% discount in the virtual catalog. In other embodiments, pricing rules may allow a specific price to be set for a product, a fixed amount to be added or subtracted from the price, no change to occur to the price, and the like.

In an embodiment, a virtual catalog allows any property of products and/or categories of a derived from catalog (e.g., virtual or base catalog) to be overridden (e.g., changed) in the virtual catalog. Such properties may include, for example, name, description, price, part number, manufacturer, weight, size, ranking, and any other property associated with a product.

For example, in a catalog, categories and products may be ranked to control how they are displayed to end users. Fast selling products may be ranked above general products and displayed accordingly to the end users. In a virtual catalog, this ranking may be overridden. Overriding ranking may be used, for example, in creating virtual catalogs based on different geographies. For example, a virtual catalog that is created for customers in Canada may have an ordering based on the customer trends in Canada while another virtual catalog that is created for customers in the United States may have an ordering based on customer trends in the United States.

To change a description of a product found in another catalog, for example, a virtual catalog may override the description property of a product or category to change the description property to another value (e.g., string of text) in the virtual catalog.

The other value to which the property is changed may be derived from a property of the derived from catalog or may be non-derived. For example, in a derived property, an overridden text value may include text from the derived from property and additional text. For example, a product description may include some or all of the product description of the derived from catalog and additional description. In a non-derived property, the property in the virtual catalog does not depend on the property in the derived from catalog. For example, the product description in a virtual catalog may entirely replace the product description of the derived from catalog.

Products and variants may be associated with inventory properties. Inventory properties may indicate on-hand quantity, on-order quantity, preorder quantity, and many other properties that are useful in maintaining inventory and supplying a product to customers. Inventory properties may be stored separately (e.g., in the inventory database 315) or together with other properties about a product. In an embodiment, the inventory properties may be overridden, instead of or in addition to other property values, in creating a virtual catalog.

In an embodiment, certain properties (e.g., computed properties, identifying properties, and so forth) may not be overridden when creating a virtual catalog.

In an embodiment, the rules for creating a virtual catalog include rules related to overridden properties. Any property that is not overridden by the rules associated with a virtual catalog receives its values from the derived from catalogs. For included catalogs, products, and variants, a property that is changed in a base catalog propagates to or affects a property in the virtual catalog as long as the virtual catalog has not overridden the property with a fixed value. For example, if the virtual catalog has a rule that increases the price by 10% and the price in the base catalog changes, this change may propagate to the virtual catalog where it may be reflected with a 10% increase from the changed price.

If the virtual catalog has a rule that fixes a property, a change in the property in a derived from catalog may not propagate to the virtual catalog. For example, if the virtual catalog has a rule that fixes a price at $100, a change in the property in a derived from catalog may not change the price in the virtual catalog.

The same principles for overriding properties may also apply to text and other properties. For example, a product description property may include some or all of the product description of the derived from catalog and additional description. As another example, a part number in a virtual catalog may include the part number found in a derived from catalog plus some additional text. In a fixed text or other property, the property in the virtual catalog does not depend on the property in the derived from catalog. For example, a vendor may desire to have a completely different part number listed in a virtual catalog.

In an embodiment, the rules specifying how to create a virtual catalog may be used to follow contractual obligations between vendors. For example, Vendor A may negotiate a contract with Vendor B regarding pricing, quantity, and so forth regarding one or more products. Vendor A may agree to allow its catalog and inventory databases to be used by Vendor B in selling and marketing the products. By establishing appropriate rules in a virtual catalog, Vendor B may encode some of the contractual obligations agreed upon between Vendor A and Vendor B.

In operation, the catalog aggregator 305 reads the rules for creating a virtual catalog from the aggregation database 320. These rules indicate which catalogs, categories, products, and/or variants to include in the virtual catalog as well as properties to override. The catalog aggregator 305 uses these rules and obtains the catalogs, categories, products, and/or variants from the catalog database 310 or from an existing virtual catalog. Properties are overridden as appropriate.

In order to increase the performance for accessing virtual catalogs, virtual catalogs may be materialized. In one embodiment, a materialized virtual catalog is a snapshot representation of the contents of the included catalogs at the time the materialized virtual catalog is materialized. Any changes made to the inherited catalogs are not reflected in the materialized virtual catalog until it is rebuilt. Once most updates are completed for a virtual catalog, the catalog aggregator 305 may store the virtual catalog in the materialized database 325. The catalog aggregator 305 may access the virtual catalog from the materialized database 325, instead of recreating the virtual catalog by applying the rules from the aggregation database 320 to the catalog and inventory databases 310 and 315.

In one embodiment, a materialized virtual catalog may be stored in the aggregation database 320. In this embodiment, the materialized database 325 may be omitted.

Periodically, a materialized virtual catalog may be rebuilt to keep it in-synch with its derived from catalogs. When rebuilding a materialized virtual catalog, instead of recalculating based on an entire catalog and inventory data, just changes that have occurred since the last building of the materialized virtual catalog may be used during the rebuilding process. For example, a database may store a modification timestamp with a row each time the row is modified. By selecting all rows with a modification timestamp greater than the time of the last rebuild, only rows that have changed may need to be evaluated in creating a new materialized virtual catalog.

In some embodiments, virtual catalogs may not automatically get a database timestamp each time a derived from catalog changes. In such embodiments, the catalog aggregator 305 may update modification fields in rows of appropriate virtual catalogs when changes occur in derived from catalogs. These fields may be used to determine changes when a materialized virtual catalog that is derived from a virtual catalog is rebuilt.

In one embodiment, a web service 330 may allow clients with web browsers to access the virtual catalogs created by the catalog aggregator 305. In another embodiment, a database access service 335 may allow clients to access the virtual catalogs through the use of database protocols. In some embodiments, clients that wish to access a virtual catalog use the service that is available and translate the received data as appropriate to the requesting process. For example, a database client may access the data of a virtual catalog via the web service 330 and translate the received data into data appropriate for the database executing on the client.

In one embodiment, a database includes some sort of structured repository from which data may be accessed. Such repositories may include, for example, relational databases, object oriented databases, HTML files, XML files, spreadsheets, flat files, and other repositories. In another embodiment, a database may include any data store or component that provides data. For example, a database may include a component that searches other data stores to obtain data that is then provided to a requestor of the data. A database may reference a set of data that is read-only to the database or may have the ability to read and write to the set of data.

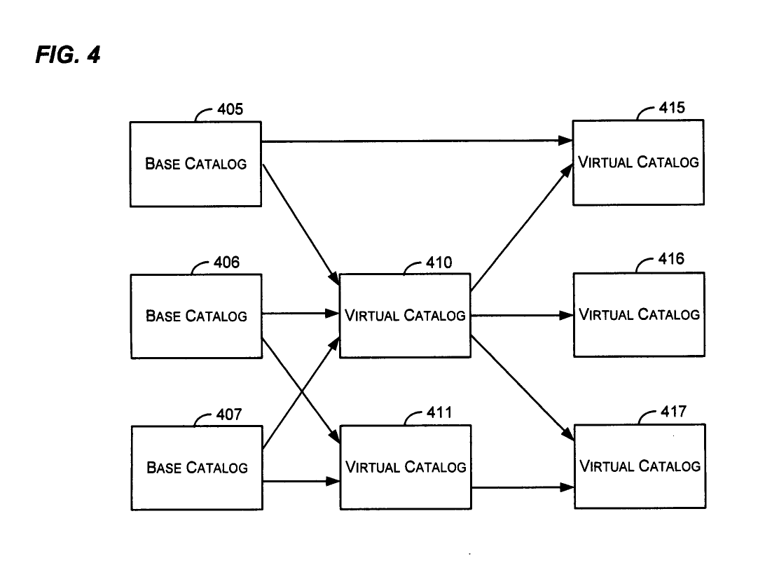

FIG. 4 is a block diagram that generally represents an exemplary relationship between catalogs in accordance with aspects of the subject matter described herein. The virtual catalog 410 is derived from the base catalogs 405-407 while the virtual catalog 411 is derived from the base catalogs 406 and 407.

The virtual catalog 415 is derived from the base catalog 405 and the virtual catalog 410. The virtual catalog 416 is derived from the virtual catalog 410 while the virtual catalog 417 is derived from the virtual catalogs 410 and 411. In an embodiment, the virtual catalog 415 may be derived from the base catalog 405 (or any set of base catalogs) but may not be derived from a base catalog and a virtual catalog. In an embodiment, the virtual catalog 417 may be derived from the virtual catalog 410 or the virtual catalog 411 but not from both.

In one embodiment a virtual catalog may be derived any other virtual catalog. In another embodiment, a virtual catalog may be derived from another virtual catalog as long as that other virtual catalog is not derived from yet another virtual catalog.

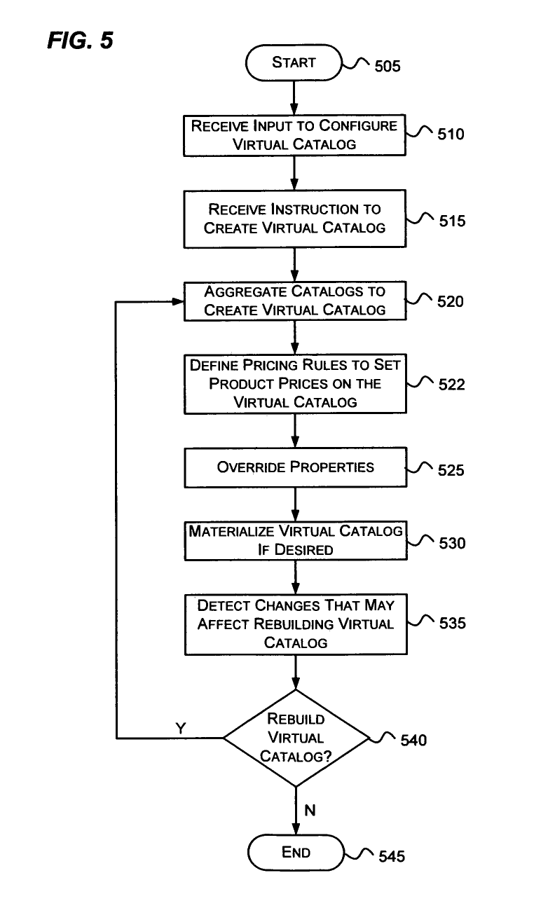

FIG. 5 is a flow diagram that generally represents exemplary actions that may occur in aggregating catalogs in accordance with aspects of the subject matter described herein. At block 505, the actions begin.

At block 510, input that indicates how to construct the virtual catalog is received. This input may include, for example, what catalogs, categories, products, and variants to include or exclude as well as rules for overriding properties as described previously.

At block 515, an instruction to create the virtual catalog is received. For example, via a user interface of a client computer, a user may ask a catalog component to create a virtual catalog that the user previously configured.

At block 520, the virtual catalog is created. This may involve aggregating other catalogs and including and excluding categories, products, and variants therefrom as previously described.

At block 522, pricing rules are defined to set product prices on the virtual catalog.

At block 525, the properties are overridden as specified. In one embodiment, this action is performed while the actions associated with block 520 are performed. In another embodiment, this action is performed after the actions associated with block 520 are performed.

At block 530, the virtual catalog is materialized. This may involve storing a copy of product information from base catalogs from which the virtual catalog is derived. This copy of product information may include the data of the base catalogs that have been included via the configuration rules while excluding other data excluded via the configuration rules. Thus, in one embodiment, this copy may not include a complete copy of all the data in all the base catalogs from which the virtual catalog is derived.

At block 535, changes that may affect rebuilding the virtual catalog are detected. In some cases, this is done by flagging a change in a virtual catalog when derived from data changes as previously. In another embodiment, this involves comparing a database created timestamp with a time at which the virtual catalog was created or rebuilt as previously described.

At block 540, a determination is made as to whether to rebuild the virtual catalog. If so, the actions continue at block 520 where changes in the base catalogs may be used to rebuild the virtual catalog; otherwise, the actions continue at block 545.

Determining to rebuild the virtual catalog may result from explicit user instruction or through an automatic process (e.g., periodically, after a certain number or percentage of changes, and the like).

At block 545, the actions end.

In one embodiment, the actions described in conjunction with FIG. 5 are not all-inclusive of all the actions that may be taken in creating a virtual catalog. Furthermore, although the actions are described as occurring in a particular order, in other embodiments, some of the actions may occur in parallel, may be performed with other actions, or may be performed in another order without departing from the spirit or scope of the subject matter described herein.

In an embodiment, a retailer may use aspects of the subject matter described above to create seasonal catalogs such as spring, summer, fall, winter, and even more time-limited catalogs, such as spring break, back-to-school, father's day, mother's day, and the like from one or more other catalogs. The retailer may create other virtual catalogs that are derived from one or more of these seasonal catalogs to target classes of customers such as those who spend more, those who spend less, those who spend for families, younger customers, older customers, other classes of customers, and the like.

In another embodiment, a retailer may use aspects of the subject matter described above to aggregate a set of vendor catalogs into a large virtual catalog and then to offer views on this virtual catalog that are customized based on the class of customer. For example, an electronics retailer may aggregate a large set of other electronic catalogs to create a large virtual catalog and may then create other virtual catalogs that are customized based on whether the customer is in a class including home, business, government, educational, and the like.

As can be seen from the foregoing detailed description, aspects have been described related to customizing and aggregating catalogs. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
receiving input that indicates at least two catalogs from which to create a virtual catalog having products from the at least two catalogs;
aggregating the at least two catalogs to create the virtual catalog, wherein aggregating the at least two catalogs includes applying any include rules and any exclude rules; and
overriding at least one property of at least one of the at least two catalogs in aggregating the at least two catalogs to create the virtual catalog, wherein the at least one property comprises a property other than a price property.

2. The computer-readable medium of claim 1, wherein at least one of the at least two catalogs comprises a base catalog in which categories, products, and variants are defined.

3. The computer-readable medium of claim 2, wherein an include rule indicates a category to include in the virtual catalog, wherein the category is from at least one of the at least two catalogs.

4. The computer-readable medium of claim 3, wherein the category is part of a hierarchy of categories and wherein including the category comprises including each category that is under the category in the hierarchy and each product associated therewith.

5. The computer-readable medium of claim 2, wherein an include rule indicates a product to include in the virtual catalog, wherein the product is from at least one of the at least two catalogs.

6. The computer-readable medium of claim 2, wherein an exclude rule indicates a catalog or product to exclude in the virtual catalog, wherein the catalog or product is from at least one of the at least two catalogs.

7. The computer-readable medium of claim 1, wherein the at least one property comprises an inventory property.

8. The computer-readable medium of claim 1, wherein the at least one property comprises a name, description, part number, rank, or manufacturer.

9. The computer-readable medium of claim 1, wherein overriding at least one property of at least one of the at least two catalogs in aggregating the at least two catalogs to create the virtual catalog comprises deriving a new value for a property in the virtual catalog based on the at least one property.

10. The computer-readable medium of claim 1, wherein overriding at least one property of at least one of the at least two catalogs in aggregating the at least two catalogs to create the virtual catalog comprises setting a fixed value to a property in the virtual catalog regardless of the at least one property.

11. The computer-readable medium of claim 1, further comprising overriding a price property of at least one of the at least two catalogs in aggregating the at least two catalogs to create the virtual catalog.

12. The computer-readable medium of claim 1, wherein at least one of the at least two catalogs comprises a virtual catalog that is derived from at least one other catalog.

13. The computer-readable medium of claim 1, further comprising materializing the virtual catalog.

14. A method implemented at least in part by a computer, the method comprising:
creating a first virtual catalog from a second virtual catalog, wherein the second virtual catalog indicates an aggregation of at least two base catalogs;
overriding a property of the second virtual catalog to create a new property in the first virtual catalog; and
materializing the first virtual catalog.

15. The method of claim 14, wherein the at least two base catalogs store product information and wherein the first and second virtual catalogs store references to data in the at least two base catalogs.

16. The method of claim 14, wherein materializing the first virtual catalog comprises storing a copy of at least some product information from the at least two base catalogs.

17. The method of claim 14, further comprising detecting changes to the at least two base catalogs and rebuilding the first virtual catalog based thereon.

18. The computer-readable medium of claim 14, wherein the at least one property comprises a name, description, price, part number, rank, or manufacturer.

19. In a computing environment, an apparatus, comprising:
a catalog store structured to store and provide access to at least one catalog;
an inventory store structured to store information regarding inventory for the at least one catalog;
an aggregation store structured to store rules including rules that indicate categories and products to include from the at least one catalog and overriding rules that indicate properties associated with the at least one catalog to override; and
a catalog aggregator structured to access the aggregation store to determine categories and products to include or exclude in a virtual catalog from a catalog of the catalog store, wherein the catalog aggregator is further structured access the overriding rules to override at least one inventory property of the inventory store.

20. The apparatus of claim 19, further comprising a materialized store and wherein the catalog aggregator is further structured to materialize the virtual catalog in the materialized store.
